(19) United States
(12) Patent Application Publication
(10) Pub. No.: US 2002/0190242 A1
(43) Pub. Date: Dec. 19, 2002

(54) Composition, use of composition and electronic devices

(75) Inventors: Terence J. lillie, Rotterdam (NL); Egidius H.J. van der Veeken, Etten-Leur (NL)

Correspondence Address: Frank A. Smith, GE Plastics, One Plastics Avenue, Pittsfield, MA, 01201, US

(73) Assignee: General Electric Company

(21) Appl. No.: 09/866,810

(22) Filed: May 29, 2001

(51) Int. Cl. H01B 1/00

(52) U.S. Cl. 252/500

(57) ABSTRACT

Compositions comprising at least one thermoplastic polymer or copolymer and 0.1-5% by weight of metal coated glass flakes. The compositions can be used for the manufacture of the housing of electronic devices. Electronic devices with a housing made out of the composition of the invention.

### BACKGROUND OF THE INVENTION

Compositions comprising a thermoplastic polymeric or copolymer are generally known. They are used for the manufacture of a wide range of products like the housing of electronic devices. An example of such devices are mobile telephones. It is also known to incorporate in such compositions all kind of additives to give the manufactured products specific colors and other aesthetical effects. To this end it has become common to incorporate metallic additives like metal flakes to give the manufactured products a metallic outlook.

Some of the electronic devices need to receive electromagnetic waves. The devices can be provided for this end with external antennae. It is lately however preferred to incorporate the antennae within the interior of the housing of the electronic devices. When the housing of the electronic device is made out of a composition comprising metallic flakes, the housing shields the electromagnetic waves so that an external antenna becomes necessary again.

### SUMMARY OF THE INVENTION

The invention provides compositions comprising at least one thermoplastic polymer or copolymer and 0.1-5% by weight of metal coated glass flakes. By using metal coated glass flakes instead of metal flakes and the like it has become possible to obtain a composition which gives a metallic outlook without unduly interfering with the electromagnetic waves.

The invention also deals with the use of the claimed compositions for the manufacture of the housing of electronic devices.

The invention further relates to electronic devices with a housing made out of the composition of the invention.

### DETAILED DESCRIPTION OF THE INVENTION

The invention relates to novel compositions which comprise at least one thermoplastic polymer or copolymer and 0.1-5% by weight of metal coated glass flakes.

The thermoplastic polymer or copolymer can be any type of material that can be molded into suitable products like the housing of electronic devices. Examples of such polymers or copolymers are aromatic and non-aromatic polycarbonate polymers and copolymers, polyesters like polybutylene terephthalate, polyphenylene ethers, polyamides, polyetherimides, graft copolymers comprising a rubbery graft base upon which one or more other monomers have been grafted, such as ABS, ASA and blends comprising one or more polymers or copolymers. Particularly suitable are compositions comprising as thermoplastic polymer an aromatic polycarbonate, a rubber graft copolymer or a blend of an aromatic polycarbonate and a rubber graft copolymer.

The compositions of the invention further comprise 0.1-5%, more preferably 0.1-1.0% by weight of metal coated glass flakes. Very suitable are commercially available nickel, gold, silver or copper coated glass flakes. The use of said metal coated glass flakes can be combined with any of the above mentioned polymer, copolymers or blends of polymers and/or copolymers. The metal coated glass flakes preferably have a mean diameter of about 10 to 200 micrometer. The thickness of the flakes is preferably between 2 and 10, more preferably between 4 and 6 micrometer.

The compositions of the invention may comprise all usual additives provided such additives do not interfere with electromagnetic waves. Examples of suitable additives are fillers like glass fibers, flame retardant additives, release agents, plasticizers, stabilizers and the like.

The properties of all and each of the described blends of the invention make them suitable for use in the manufacture of the housing of electronic devices which are provided with circuitry suitable for exchange of information at radio frequencies of 500 MHz to 3 GHz, more in particular in the range of 1.5 to 3.0 GHz, more in particular in the range of 2.4 to 2.48 GHz.

The invention therefor also relates to electronic devices provided with a housing made out of any of the compositions of the invention described herein. Suitable electronic devices are for example communication devices such as mobile telephones, devices used for remote control of apparatus by electromagnetic waves and apparatus provided with receptors for the electromagnetic waves of remote control devices. Examples of such devices are cordless keyboards for computers and remote controlled video equipment.

### EXAMPLES

Three different compositions (numbered 1-3) have been prepared by melt mixing according to standard techniques 74 parts by weight of an aromatic polycarbonate (PC) derived from bisphenol A with 26 parts by weight of an ABS resin. In composition 2 have been incorporated 1% by weight (calculated with respect to the weight of PC and ABS) of aluminum flakes ( mean diameter: 95 micrometers and thickness 0.8 micrometer) and in composition 3 (according to the invention) 1% by weight of silver coated glass flakes (mean diameter: 90 micrometer and thickness 5 micrometer). Plaques molded out of composition 1 did not have a metallic appearance, whereas plaques molded out of compositions 2 and 3 had a similar sparkled metallic effect.

The dielectric properties i.e. the dielectric constant and the dielectric loss tangent of each of the plaques have been determined with a split-post resonator at a frequency of 2.4 GHz. The split-post dielectric resonator is suitable device for a non-destructive test for measuring the dielectric constant and the dielectric loss constant of non-conducting low loss materials in the GHz-range. For the measurement plaques with a dimension of about 70×70×1.5 millimeters have been used. All measurements are referenced to a standard certified by the U.S. National Institute of Standards and Testing (NIST).

The obtained results are summarised in the following Table. As can be seen from the Table the dielectric constant of all three compositions is about the same, while the loss tangent is for the composition of the invention (no. 3) significantly lower than of comparative composition no 2. Composition no. 3 is thus more suitable for use in the manufacture of the housing of electronic devices that need to receive electromagnetic waves than composition no. 2. Articles molded out of composition no. 3 have contrary to articles molded out of composition no. 1 the desired metallic look.

TABLE

| | | DIELECTRIC | DIELECTRIC |
|---|---|---|---|
| COMPOSITION # | ADDITIVE | CONSTANT | LOSS TANGENT |
| 1 | none | 2.72 | 4.50 E-03 |
| 2 | 1% by wt. Al flakes | 2.86 | 50.6 E-03 |
| 3* | 1% by wt. Ag coated | 2.89 | 33.3 E-03 |
| | glass flakes | | |

*Composition of the invention

What is claimed is:

1. Composition comprising at least one thermoplastic polymer or copolymer and 0.1-5% by weight of metal coated glass flakes.

2. Composition of claim 1 comprising as thermoplastic polymer an aromatic polycarbonate, a rubber graft copolymer or a blend of an aromatic polycarbonate and a rubber graft copolymer.

3. Composition of claim 1 comprising nickel, gold, silver or copper coated glass flakes.

4. Composition of claim 2 comprising nickel, gold, silver or copper coated glass flakes.

5. Use of the composition of claim 1 for the manufacture of the housing of electronic devices which are provided with circuitry suitable for exchange of information at radio frequencies of 500 MHz to 3 GHz.

6. Electronic devices provided with a housing made out of the composition of claim 1.
